(19) United States
(12) Patent Application Publication
(10) Pub. No.: US 2004/0193691 A1
(43) Pub. Date: Sep. 30, 2004

(54) System and method for providing an open eMail directory

(76) Inventor: William I. Chang, Saratoga, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 10/814,010

(22) Filed: Mar. 30, 2004

Related U.S. Application Data
(60) Provisional application No. 60/458,287, filed on Mar. 31, 2003.
(60) Provisional application No. 60/540,989, filed on Jan. 31, 2004.

(51) Int. Cl. G06F 15/16; G06F 7/00; G06F 17/30

(52) U.S. Cl. 709/206; 709/245; 707/3

(57) ABSTRACT

An eMail directory and forwarding service charge an eMail message sender a refundable sender's fee for each eMail message sent. The amount charged is specified by the recipient. The eMail directory allows an eMail message recipient to be located in a search by other users or commercial senders using biographical and affinity information voluntarily provided by the recipient in a profile database. Thus, based on his perception of the value of his time, the recipient may set his price for reading an eMail message. In turn, a sender (e.g., a commercial sender) can bid for the recipient's attention by paying the specified fee, or if the sender would like greater attention, a greater fee. A content search gateway collects information regarding a subscriber's search interests to include as affinity information in the profile database. Various information and email services are provided to foster an online community.

### CROSS-REFERENCE TO RELATED APPLICATIONS

The present application is related to and claims priority under 35 U.S.C. § 120 to (1) provisional patent application, serial No. 60/458,287, entitled “Open eMail Directory, Safe from SPAM, Supported by Advertising,” filed on Mar. 31, 2003, and (2) provisional patent application, serial No. 60/540,989, also entitled “Open eMail Directory, Safe from SPAM, Supported by Advertising,” filed on Jan. 31, 2004.

### BACKGROUND OF THE INVENTION

1. Field of the Invention

The present invention relates to application computer programs operating in the internet environment. In particular, the present invention relates to efficient use or management of electronic mail (“eMail”) resources on the internet, such as the control of unsolicited eMail messages (“spam”), including eMail messages from commercial senders. The present invention also relates to providing an identity registry and a sender verification service.

2. Discussion of the Related Art

In March, 2003, it is reported that 41% of all eMail traffic on the internet is “spam”(i.e., unsolicited electronic mass mailing), using aggregated lists of eMail addresses culled from the internet and resold for this purpose. Since March 2003, spam has increased to between 50% and 75% of all eMail traffic according to various surveys. Spam content is often highly objectionable (e.g. pornographic). In response to this pandemic, many users and their eMail service providers use “filter” software to screen spam. However, such screening is at best only partially effective. On one hand, if a filter is set too stringently, it is possible that legitimate eMail messages may be erroneously and unintentionally removed. On the other hand, a less stringent filter may allow an undesirable number of spam messages to pass undetected through the filter.

As the skills and the technology available to the “spammers” become more sophisticated, even the more stringent filters can be defeated. Meanwhile, as the user's mailbox is filled with spam, legitimate eMail messages are increasingly likely to be overlooked by the intended recipient in the sea of spam. Consequently, legitimate transactions and opportunities may be lost. Also, when national and regional internet service providers (ISPs) go out of business, often with little prior warning, it leaves a large number of dead (i.e., out-of-service) eMail addresses. As a result, affected users lose their personal and business connections. Dead eMail addresses can also result from people changing jobs, schools, or ISPs. Meanwhile, although one can still use a search engine to search for an eMail address, people are increasingly reluctant to make their eMail addresses available in public for fear that they may be “harvested” by the spammers. Thus, the convenience and connectedness provided by eMail service are significantly degraded. At the same time, companies and other commercial senders (e.g., direct marketers) who would like to reach qualified customers and consumers are finding their messages increasingly drowned out by spammers who can indiscriminantly “shot-gun” spam at virtually no cost to themselves.

One recent response to the growing spam problem is the development of eMail software “plug-ins” which attempt to verify the sender through an auto-reply process. Such plug-ins are, however, inconvenient to install and to use. Another development is a “sender bond” software product that is available from Vanquish, Inc., Marlborough, Mass. Such a system, however, is too limited in scope. Thus, a solution is needed that allows a user to manage the amount of spam targeting his mailbox, while allowing legitimate mass eMail mailings to reach willing recipients.

### SUMMARY

An eMail directory and forwarding service charges an eMail message sender a refundable sender's fee for each eMail message sent. The amount charged is specified by the recipient. The directory allows an eMail message recipient to be located in a search by other users or commercial senders using biographical and affinity information voluntarily provided by the recipient. The directory service provider may receive a percentage of the sender's fee. If an eMail message is not “picked up” by the recipient within a time frame specified by the sender, the eMail message is cancelled and the sender's fee returned. The recipient can also elect to return any portion of the sender's fee, if the sender is a friend or someone who shares an affinity. Thus, based on his perception of the value of his time, the recipient may set his price for reading an eMail message. In turn, a sender (e.g., a commercial sender) can bid for the recipient's attention by paying the specified fee, or if the sender would like greater attention, a greater fee.

The services provided by the present invention include an internet identity registry and a sender verification service. The present invention also provides enhancements to search, eMail forwarding, direct marketing, and online community and marketplace services.

According to one embodiment of the present invention, an internet identity registry allows verification of the identity of an eMail sender or recipient, or an internet user in general. The identity registry can also be searched by identity or affinity. In one embodiment, the present invention provides other services in addition to eMail. By combining a fee-based eMail forwarding service with a searchable directory of verified senders and recipients, the present invention achieves anti-spam, social networking, question-answering, targeted advertising and direct marketing objectives simultaneously. The present invention therefore achieves both high acceptance by its users and financial viability for its providers.

In one embodiment, the sender's fee may be split among the mail forwarding service, the recipient, and—as a financial incentive—a “referrer” who refers the recipient to the service. The referrer may be an individual member or an organized group of people, such as a club or a moderated mailing list.

The present invention is better understood upon consideration of the detailed description below and the accompanying drawings.

### BRIEF DESCRIPTION OF THE DRAWINGS

FIG. 1 is a block diagram illustrating an architecture for affinity portal 100, in accordance with one embodiment of the present invention.

FIG. 2 is a block diagram illustrating the operations of eMail directory & forwarding service, provided in accordance with one embodiment of the present invention.

FIG. 3 is a block diagram illustrating in further detail the operations of message forwarding service 106.

FIG. 4 is a diagram illustrating the treatments of sender's fees according to different classes of senders.

FIGS. 5 and 6 are flow diagrams illustrating the operations of message forwarding service 106 when a member accepts or returns a sender's fee, respectively.

FIG. 7 is a block diagram illustrating the operations of “search oracle” service, one class of subscriber content queries 107, provided in accordance with one embodiment of the present invention.

FIG. 8 is a block diagram illustrating the operations of sender verification and invitation service, a component of message forwarding service 106, provided in accordance with one embodiment of the present invention.

FIG. 9 is a block diagram illustrating the operations of consumer gateway service 101, provided in accordance with one embodiment of the present invention.

FIG. 10 is a block diagram illustrating eMail marketing service (“second-chance search advertisement”), a form of consumer gateway service 101, provided in accordance with one embodiment of the present invention.

FIGS. 11 and 12 illustrate taxonomies and multi-dimensional queries parametrized by such taxonomies, respectively for a people directory and for a product catalog, in accordance with one embodiment of the present invention.

FIG. 13 illustrates the “vouch-for” relationship (a form of contact list) and its usefulness in rating and tracing both members and non-members, in accordance with one embodiment of the present invention.

FIG. 14 summarizes the various, optional, steps in the user registration process, in accordance with one embodiment of the present invention.

FIG. 15 is a block diagram illustrating the operations of a sender verification service when the sender is roaming and needs to add a previously unknown eMail server (identified by its origin IP address) as a valid designated sender, in accordance with one embodiment of the present invention.

### DETAILED DESCRIPTION OF THE PREFERRED EMBODIMENTS

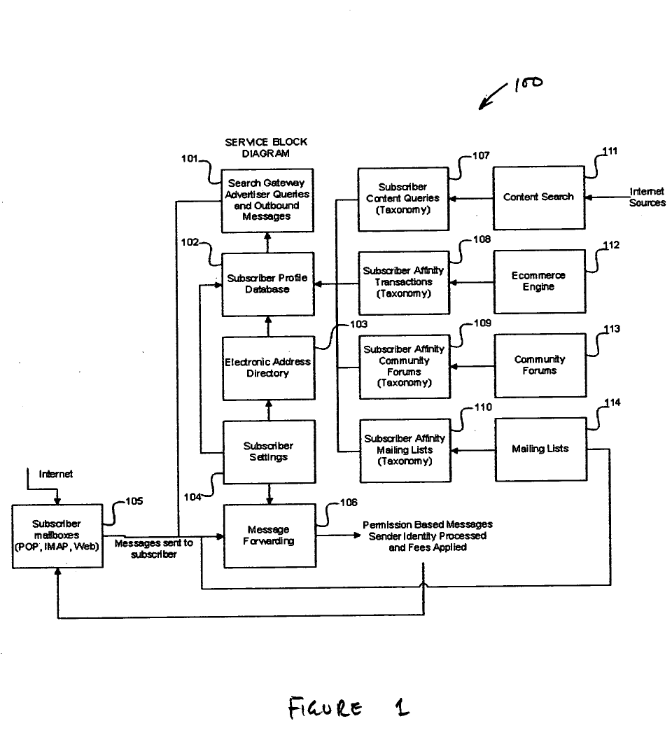

According to one embodiment of the present invention, illustrated by the block diagram of FIG. 1, affinity portal 100 provides eMail and online community services. As shown in FIG. 1, affinity portal 100 is organized around a subscriber profile database 102 and electronic addresses directory 103, and search capability provided by one or more scalable, real-time parametric search engines, which can perform low-level search on the databases and on the world wide web (WWW) of the Internet. These engines provide a platform to build a number of services that are discussed in further detail below.

Subscriber profile database 102 registers biographical and “affinity” information provided by its subscribers or members. Typical biographical information includes, for example, the member's full name, maiden name, photograph, birthplace, education and work address. Typical affinity information includes the member's life history, expertise, hobbies, club memberships, collectibles, list of items for sale, list of items desired (“wish-list”), and geographical region of the member's residence. According to the member's preference and instructions, both biographical and affinity information are optional and access-controlled. Access control levels may include such levels as private, clique, club, public and advertiser. In addition, subscriber profile database is augmented by information extracted by affinity portal 100 from (1) subscriber content queries 107, which are subject matters of content searches 111 performed by the members; (2) subscriber affinity transactions 108, which are subject matters of members' commercial electronic transactions (e.g., on-line purchases) recorded, for example, by e-commerce engine 112; (3) subscriber affinity 109 from community forums 113, which represent the members' interests categorized by the types and subject matters of activities the members conduct in on-line (“virtual”) communities; and (4) subscriber affinity 110 from mailing lists 114, which represent the members' interests as categorized by the subject matters of mailing lists in which the members participate. The members control access to the information in subscriber profile database 102 through subscriber settings 104.

Subscriber settings 104 also controls forwarding of eMail or electronic messages addressed to the subscribers by message forwarding service 106. For example, subscriber settings 104 allow each subscriber to specify one or more minimum sender's fees, as a condition for forwarding electronic messages in subscriber mailboxes 105 received from specified classes of electronic message senders. Thus, a member of affinity portal 100 may condition his “picking up” an eMail message¹ sent to the member through affinity portal 100 to receiving a sender's fee. After the first contact, the member may reclassify the sender to another class, e.g., “friend”, so that the sender may be charged a lesser or no sender's fee for subsequent eMail messages. ¹ “Picking up an eMail message” refers to one or more of the following activities: examining messages sent to a mailbox, identifying an eMail message sent to a mailbox, opening the eMail message for reading, and deleting, marking as read, saving or replying to the eMail message, or adding the sender's name, or another's name, and eMail address to an address book.

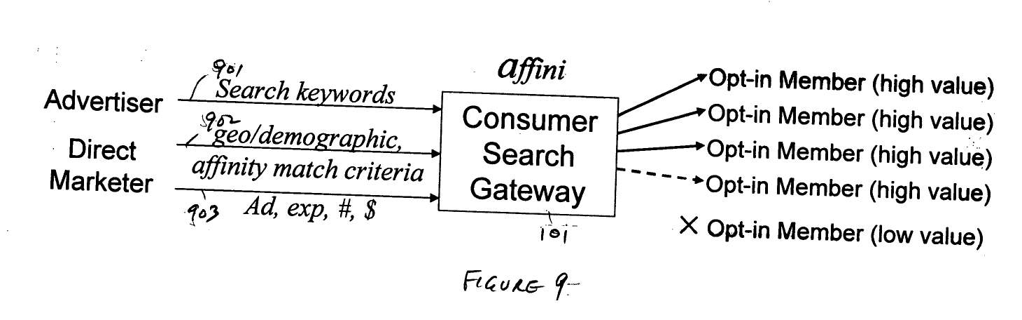

Electronic address directory 103 allows affinity portal 100 to offer “consumer search gateway” service 101, whose operations are illustrated by FIG. 9, enabling anyone (e.g., any commercial advertiser or direct marketer) who wishes to contact the registered members of affinity portal 100 to search the portal based on keywords (901), biographical or affinity information (902), or by the required amounts of sender's fees (903). Email messages may then be sent to the members on the search results by paying—electronically or otherwise—the specified sender's fees. Consumer search gateway 101 thus provides commercial senders high-value qualified targets who are carefully matched to the commercial sender's specified target profiles. In one embodiment, to prevent the eMail addresses retrieved being harvested by a commercial sender for resale, the eMail addresses retrieved are not revealed to the requesting commercial sender. Alternatively, certain users may have effective spam-filters installed and thus are immune to spamming, and may allow their eMail addresses to be revealed to the requesting commercial sender.

In one embodiment, a sender may obtain priority over other senders by offering a premium fee (e.g., in the case where a member of the affinity portal sets a daily maximum limit on the number of eMail messages that the member desires to receive from unsolicited sources). Any eMail message that is not picked up by the designated recipient within a sender's specified time period is automatically cancelled and its associated sender's fee refunded. At the same time, an eMail message sent without going through affinity portal 100 may trigger a sender's fee invoice to be sent from the affinity portal to the sender. In that situation, the eMail message is not forwarded to the member until the invoice is paid.

In summary, the detailed profile information—whether declarative, behavioral, or search-based—that is compiled from the many services of affinity portal 100 (e.g., content search, mailing lists, community forums) enables a commercial marketer to target its audience to a degree not previously available. Thus, the objectives of maximizing revenue efficiency, user satisfaction (both sender and recipient), and the manageability of advertising campaigns are achieved. A commercial sender can specify multiple criteria (including keywords) and the number of eMail advertisements delivered or outstanding over any time period (i.e., “throttling”). When any of the outstanding advertisements is selected by a recipient or expires due to non-selection over the specified timer period, message forwarding service 106 can automatically “roll over” the advertisement to the next matching member, sorted in order of user value and expected performance of the advertisement. The high relevance of the advertisements as well as the fact that user has control over the sender fee and possibly shares it with his affinity referrer, will make such advertising desirable to the member.

In one embodiment, affinity portal 100 provides tools to foster online community activities, such as search and topic hierarchies. Affinity portal 100 provides community forums 1 13 and mailing lists 114 to facilitate the congregation of its members and formation of groups. In the terminology of the affinity portal, a “clique” refers to a group eMail alias, including certain group attributes, which forwards eMail messages to its members. A “club” refers to an environment that is richer or more sophisticated than a clique. A club offers features such as a homepage, a message board, directories of people, sites or things associated with the club, a searchable list of “frequently asked questions” (i.e., “FAQs”), access to shared files, images, calendar, classified advertising, and links to other sites of interests (e.g., on-line auction sites, OpenDirectoryProject, searchable categories, other online groups or other related online communities). Club members of a hobby group can, for example, describe their collections, including identifying parts of their collections as for sale or trade, and items wanted to complete their collection, using a search and categorization method, such as that described below. A club typically includes one or more administrators and moderators, and can set rates for advertising on the club's web pages or directly marketing to the club members via eMail. Clubs can exchange “ad banners or links” with other groups to market themselves to prospective members.

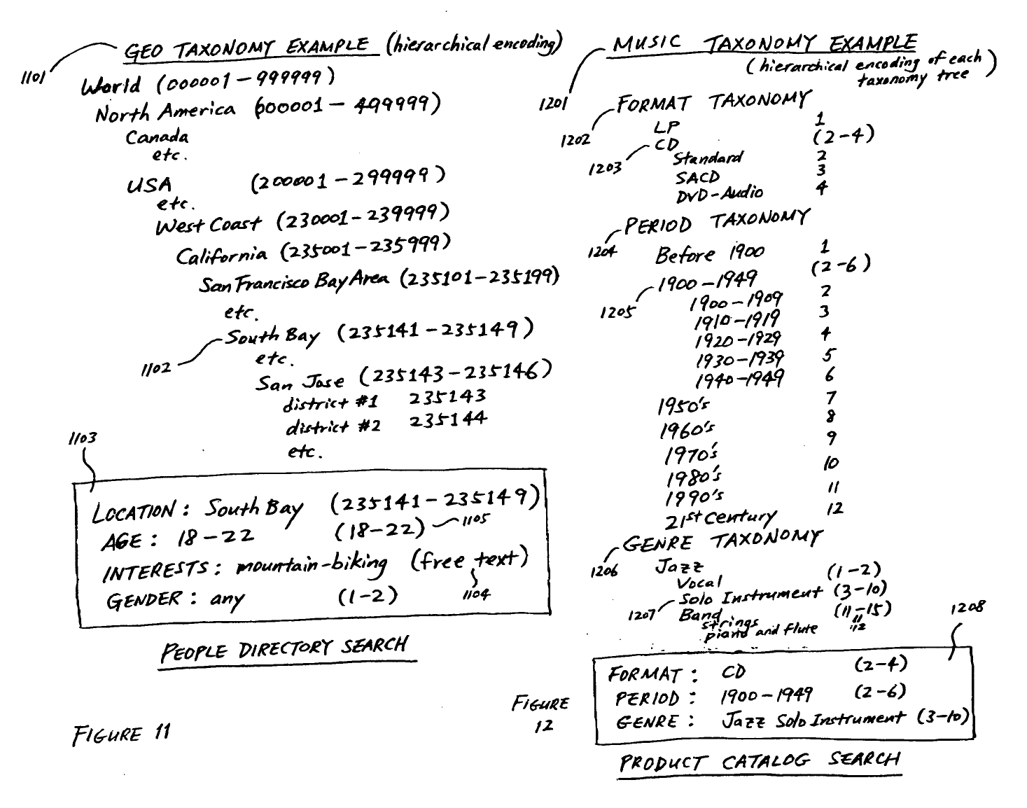

In one embodiment, the present invention organizes affinity portal 100 according to a collaborative taxonomy and categorization tool. Conventional online communities are organized or categorized according to a single, large hierarchical taxonomy or ontology that is difficult to navigate and to maintain (collaboratively or otherwise). According to the present invention, however, the taxonomy and categorization tool categorizes according to multiple, independent user-defined properties relevant to each affinity group, as illustrated in FIGS. 11 and 12. Each property then results in a hierarchical taxonomy tree (e.g., taxonomy tree 1101, 1202, 1204, or 1206), which is more natural and usually much smaller in the number of possible attribute values for that property than would be expected for a single, large hierarchical taxonomy. A simple list or range of values is a special case of the more general, multi-tier taxonomy tree. The leaves and nodes of the taxonomy tree are assigned numerical values or ranges of numerical values in a hierarchical manner. A leaf or node belongs in a subtree if the value or range of values assigned to the leaf or node lies within the numerical range assigned to the subtree. For example, in taxonomy tree 1101, the subtree South Bay (assigned the range of 235141-235149) is a node in the subtree California, which is assigned the range of 235001-235999.

Thus, instead of having thousands of categories that are inter-related in complex ways, the present invention provides a method that “factors the search space” according to independent, sensible and manageable properties. The properties can be initially seeded by a group of experts; these properties can then be refined and extended over time from the member inputs. Where alternative taxonomy choices exist, each alternative can be treated as an independent property until a de facto standard is found through actual use. The categorization according to the present invention is naturally simpler and more accurate, as the taxonomy is more rational. In any search that traverses one or more taxonomy trees, a member can restrict search or navigation by selecting only a subset (e.g., 1102, 1203, 1205, and 1207) of the allowable range of values in each property involved in the search, thereby finding or traversing only a subtree in the taxonomy tree for that property, or only a range of values delimited by nodes 18 and 22 of the subtree 1105, possibly in conjunction with fielded, free-text keywords 1104. One aspect of this categorization method allows each dimension or property to be sorted and queried according to a taxonomy tree (e.g. 1101, 1202, 1204, or 1206) and not just as a list of possible attribute values. Consequently, more rational, extensible, scalable, and easy-to-use real-world taxonomies can be created and managed efficiently and collaboratively. Thus, buyers, sellers, and commercial users can match interests 1103, 1208 and find specific affinity groups or individuals. Affinity portal 100 may encompass and categorize a universal, living directory of goods 1201 as well as people according to topics of interest.

As discussed above, an eMail counter-spam method according to one embodiment of the present invention requires a sender's fee for unsolicited eMail. This method not only reduces the volume of unsolicited eMail messages received by a member, it also provides commercial senders (e.g., direct marketers) potential target consumers selected by desired attributes (e.g. income, neighborhood, life-style indicators). For commercial senders, the sender's fee is a reasonable price to pay for a quality, willing mailing list. Since the sender's fee is specified by the recipient in return for a promise to consider the associated eMail message, the sender's fee assures that the commercial sender's eMail messages will receive attention. At the same time, the recipient's time to manage the eMail messages is also properly valued. In other words, the recipient trades off his tolerance for unsolicited eMail messages for the sender's fee received. Some recipients may be willing to receive or read solicitations for a miniscule amount of sender's fee, while others recipient may request significantly higher fees. Thus, this method allows the market forces to determine a price for advertising, thereby benefiting both the senders and the recipients.

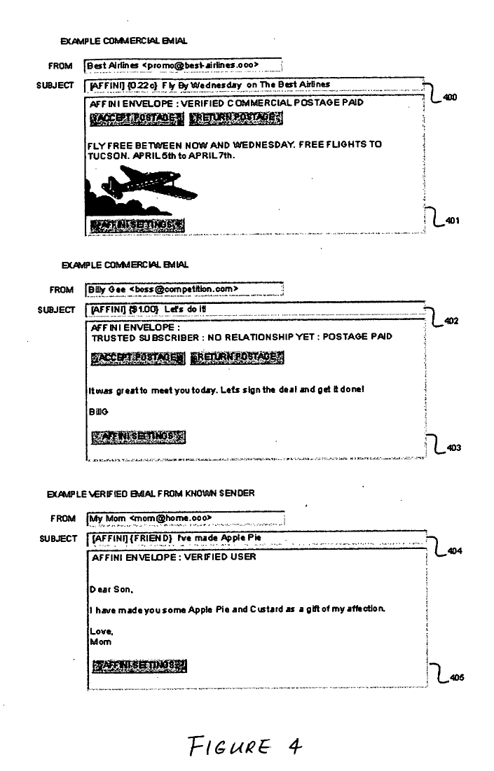

According to one embodiment of the present invention, FIG. 4 is a diagram illustrating the treatments of sender's fees according to different classes of senders. As shown in FIG. 4, to implement the sender's fee feature, the header subject fields 400, 402 and 404 of eMail messages 401, 403 and 405, or another field, is tagged to indicate the amount of fee being paid or offered. In FIG. 4, messages 401, 403 and 405 correspond to eMail messages received from a verified commercial sender, an unverified commercial sender and a verified and approved no-fee sender (e.g., a “friend”). To allow the member to collect the sender's fee after having reviewed the body of the eMail message, the body of the eMail message contains a URL (i.e., a universal resource locator), or a code (e.g., the “accept postage” button presented in the body of the eMail message). The member may return the sender's fee using a similar mechanism (e.g., selecting the “return postage” button presented in the body of the eMail message). In addition, a reply to the eMail message or other transactional action may also be tracked and serve as a click-through (i.e., a recorded action with eCommerce significance). Where a mail reader provides support (e.g., customized mailboxes 105 provided by affinity portal 100), selecting the subject line brings the member to the sender's designated web page through, for example, a redirect. The designated web page may be advertising (for commercial purpose) or requests for contact (for non-commercial purposes). Additional fees may be charged on an impressions-basis as well as for click-through.

In one embodiment, sender's fees may be transferred between accounts maintained by affinity portal 100. The sender's fee may be, but is preferably not, transacted with credit cards or online payment services on a per message basis. If a sender's fee expires uncollected, it is restored to the sender's account. In addition, a member—acting as sender—may specify a maximum acceptable fee without additional request or authorization for eMail messages the member wishes to send. The member may also specified a daily or weekly limit on the number of eMail messages and total fees sent or received.

A service according to the present invention which offers a strong financial incentive for the participants should achieve quick market acceptance. The present invention also provides an on-line resource for finding people. For example, the resource may be used to find a long lost friend or relative, or to establish new relationships. (At the “friend” class, the sender's fee is most likely zero.) This sender's fee feature can also be used by experts who wish to provide pre-paid consultation services over eMail, or by celebrities who wish to make available (for a fee) personal communications or other information desired by their fans.

To facilitate the financial transactions in this online community, and to prevent identity fraud, the participants are preferably confirmed and verified in advance. When an unverified person applies to become a member, relevant biographical information is collected which may include the member's eMail address, name, and organization. The eMail address can be confirmed by the service provider sending the recipient an eMail message at the eMail address, including in the eMail message a URL that the user is required to access to confirm receipt of the eMail message and thereby the address. Alternatively, any other method for confirming the eMail address may be used. One method for verifying the identity of a member is by conducting a nominal financial transaction between the service provider and the member. Such proof of identity may include, for example, providing a verified eMail address used by an online payment service (e.g., an online payment service, or any portal or eCommerce company, especially in a “Federated Network” model), which allows a nominal deposit to be made together with a message containing a password (or URL encoding a Password) that, when exercised, will serve to verify the user. Thus, for example, a user may elect to be verified when he first becomes a member, or he may elect to remain unverified until a financial transaction occurs. The financial transaction may be, for example, payment of a sender's fee, or withdrawal of funds from the sender's fees received as a recipient. Alternatively, the member may submit a credit card number, which allows verification of name and address and allows the affinity portal to charge or credit a nominal amount to the credit card account. For security, the transaction may be password protected. A sender may also be verified by a static IP address associated with the sending eMail server. Additionally, existing members may “vouch for” the applicant user, or a member may build up a reputation or credit over time through controlled interactions within the affinity portal and with other members, or through contributions to the internet at large that can be determined by datamining the WWW and various internet archives. Conversely, the affinity portal may patrol unsanctioned or unacceptable behavior by a member by revoking membership or by placing the member on probation.

To prevent fraud, the service providers should preferably reserve user names that correspond to or resemble celebrity names. A metric to measure responsiveness or helpfulness by the recipients (i.e., a measure of “value” to the senders) should be maintained by the service provider. Alternatively, a rating system such as those maintained on online retail or auction sites, can be maintained by the participants. Such value ratings can be assessed a penalty by the service provider for misdeeds by the member or by those whom the member has “vouched for” or has rated highly. Also, ad click-through and certain resulting transactions are known to the service directly, or indirectly via the advertiser, and can affect a member's value rating.

According to one embodiment of the present invention, a transaction tracking service detects incoming registration or order confirmation eMail messages to avoid mistakenly rejecting such messages as spam and to learn the online shopping behavior of the member. The member's shopping behavior is valuable information to potential advertisers. Collecting, filing and threading confirmation eMail messages are generally helpful services to the member. Confirmation eMail messages not resulting from advertisement, or not originated from within the eMail service can still be detected, especially guided by member activities that associate the names of the senders (e.g., a member's search by name for the sender's messages).

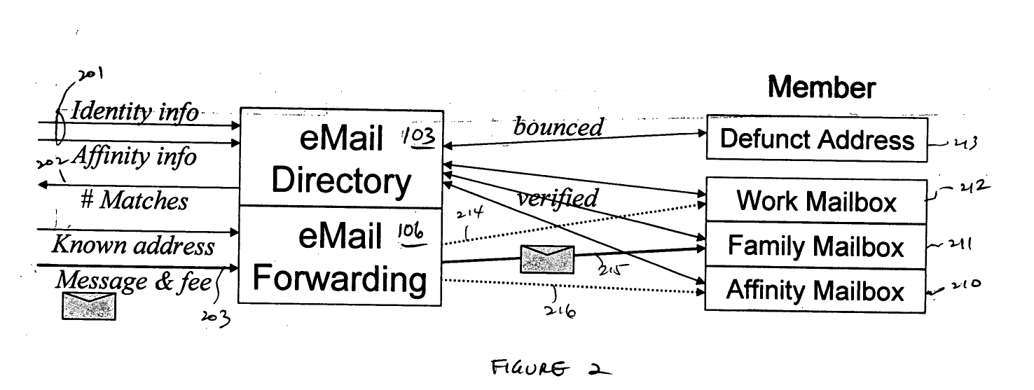

The block diagram of FIG. 2 further illustrates the operations of electronic directory service 103 and message forwarding service 106. To use searchable electronic directory service 103, a sender specifies set 201 of search criteria (e.g., identity, affinity, personal-history, and location), and obtains list 202 of members matching the search criteria. The maximum number of resulting entries in the list may also be specified. Then, the sender can use the list to send his eMail messages at the sender's fees requested by the members returned in the list. For privacy reasons, a member may request that private financial or biographical information, including the member's identity and eMail addresses, not be disclosed to the sender. In addition, a member may list with the service multiple current and past eMail addresses 210-213. Current addresses can be tagged by category (e.g. work mailbox 212, family mailbox 211, and specific affinity mailbox 210) and are each confirmed to be current by periodically sending the member an eMail message requesting a password or including an URL that the member is expected to select. For past eMail addresses (e.g., defunct address 213), an eMail message is periodically sent to the eMail address to elicit a delivery failure notice to ascertain that it has not been recycled for use by another.

Forwarding service 106 forwards eMail addressed to members. A member may specify how incoming eMail messages for a particular purpose should be routed. For example, a sender may specify a specific purpose (e.g. work, family, or specific affinity) when requesting the eMail service to forward an eMail message to a recipient. The eMail service will forward the eMail message to the selected eMail address the recipient member specifies for that purpose. This service is referred to as “eMail consolidation service”. Further, a sender can search for a member using a past eMail address (e.g. an old ISP, job, or school eMail address, such as defunct address 213), and requests the service forward an eMail message to the member's current address (e.g., any of eMail addresses 210-212). This service is referred to as “eMail portability service”.

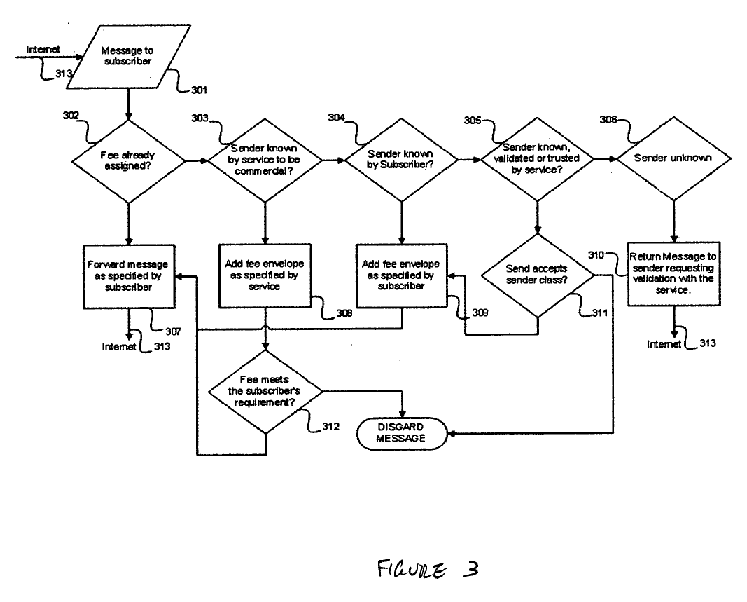

FIG. 3 is a block diagram illustrating in further detail the operations of message forwarding service 106. As shown in FIG. 3, when a message is received from the Internet, for example, message forwarding service 106 determines (step 301) the destination of the message. Message forwarding service 106 further determines (step 302) if the requisite sender's fee is provided, or if a sender's fee is not necessary. If the sender's fee is provided or is not necessary, the message is forwarded to the subscriber (step 307). If the fee is not provided, and the sender is one known to affinity portal 100, message forwarding service 106 attaches a “fee envelope” (i.e., authorizes the sender's fee) 308 according to the authorization already on file from the sender. If this sender's fee is determined to meet or exceed the sender's fee specified by the recipient (step 312), the message is forwarded to the recipient (step 307). Otherwise, the message is discarded. If a sender's fee is not provided in the message, but the sender is on a list provided by the recipient (i.e., a sender known to the subscriber) and have previously provided authorization (step 304), the message is forwarded after a fee enveloped is attached (step 309). Otherwise, i.e., the sender has not previously provided authorization (step 305), the message is held until the sender is queried and provides authorization of a sender's fee (step 311). When the sender's fee is authorized, a fee envelope is attached (step 309) and the message is forwarded. If a sender's fee is not provided and the sender is unknown to affinity portal 100 (step 306), the message is returned to the sender with instructions to register and authorize a sender's fee at affinity portal 100 (step 310).

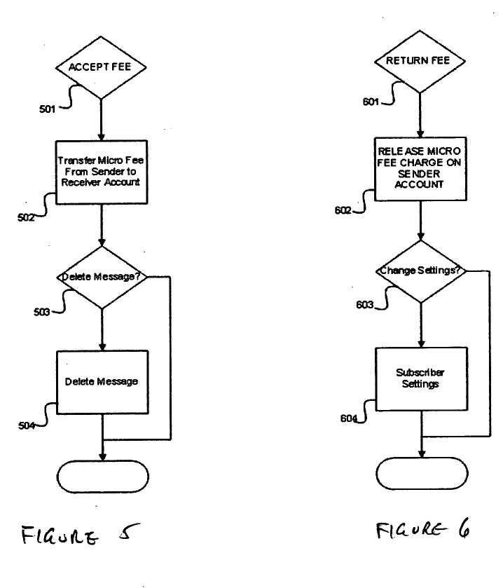

FIGS. 5 and 6 are flow diagrams illustrating the operations message forwarding server 106 when a member accepts or returns a sender's fee, respectively. As shown in FIG. 5, when the recipient accepts the sender's fee (e.g., by selecting the “accept postage”button of FIG. 4), the fee is transferred from the sender's account at affinity portal 100 to the recipient's account (step 502). The recipient, of course, may decide to delete the message after reading (steps 503 and 504). Similarly, as shown in FIG. 6, when the recipient returns the sender's fee (e.g., by selecting the “return postage” button of FIG. 4), the recipient may elect to change subscriber settings 104 to reflect a new rule to be used for the future with respect to the sender to whom the sender's fee is returned (steps 603 and 604). For example, the sender may become a “friend” or no-fee sender with respect to new messages received from the sender.

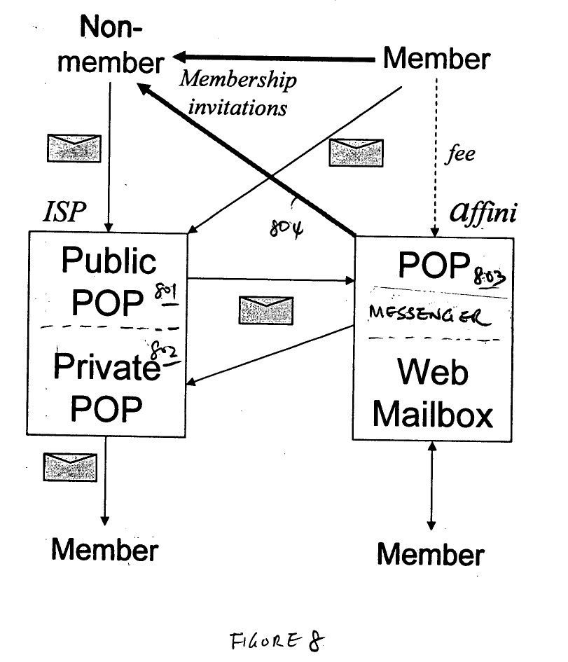

The present invention also provides an eMail “route-through” service which filters eMail messages for spam. With this service, a member may maintain all his eMail addresses, such as eMail addresses at existing ISPs or eMail providers. One embodiment, which is called the “POP Messenger” service (POP stands for the internet standard “Post Office Protocol”), illustrated in FIG. 8, requires that a member create with his ISP a private mailbox 802 (e.g. append a secret code to the public eMail address, represented by public POP mailbox 801), if needed. The member then informs message forwarding service 106 of his public and private POP mailboxes 801 and 802. Message forwarding service 106, through POP Messenger module 803, then periodically retrieves eMail messages from the public mailbox 801, performs specified filtering function (e.g., sender verification), and forwards the filtered eMail messages to the private mailbox 802. If the sender of an eMail message is not an existing member, an invitation-to-join or another appropriate notification message 804 may be sent to the sender. Any eMail message that is not delivered to private mailbox 802 (e.g., for a reason such as unverified sender, or insufficient sender's fee) may be placed in escrow with the service, left in the original public mailbox until the deficiency is corrected, or may be rejected immediately or after a specified time delay. If the sender is a member and the applicable sender's fee requested is within the sender's specified allowable limits (both for the eMail message and the sender's specified daily or weekly total, for example), the sender's fee is deducted from the sender's account, and the eMail message is forwarded to the recipient's private mailbox. Otherwise, i.e., if the sender authorization is non-conforming or deficient, a fee authorization request is sent to the sender. Requesting authorization from the sender when the eMail request is non-conforming, provides a method to catch a “spoofed” sender address (i.e., an email addressed fabricated by a spammer imposter to hide its true identity) and to prevent significant damage. If instructed by the member, the eMail service can forward unverified eMail messages to a separate mailbox set aside for probable spam.

According to another embodiment of the present invention, another eMail route-through service—referred to herein as the “POP Butler service” —does not require a separate private mailbox, unlike the POP Messenger service. The POP Butler service checks a member's public mailbox periodically or adaptively², so as to perform sender verification services. The messages may have the subject fields of their header modified to indicate status. Any probable spam messages can be deleted by the POP Butler service, or segregated from legitimate eMail messages (e.g., being sent to a holding area). The schedule for checking the public mailbox can be preset or based upon the recent frequency at which a member checks his mailbox. ² That is, the time period between activities varies according to recent frequency of activities.

Although the POP Messenger service and POP Butler service are illustrated above using POP, these eMail services can be under other eMail protocols, e.g., IMAP, web-based, and desktop client (plug-in), where multiple folders are provided and eMail messages can be moved among them. Also, if the ISP enables automatic forwarding, the member can have eMail messages forwarded to the eMail service instead of having the eMail service retrieve them from the public mailbox. The member's private mailbox may also reside with the eMail service as a value-added eMail service. Value-added eMail service may included such features as threaded messages, extensive search capabilities, automatic folder assignment³, messages sorted by sender's fee, folders for shared messages⁴, expire-on-delete of uncollected sender's fees, fee-check before send, and movement of messages between folders as verification status changed. In addition to sender verification and sender's fee-related services, other anti-spam methods can be applied to the re-routed eMail messages. ³ The member's inbox would show the auto-assignment of each message. The user may elect to have all or selected messages moved to the assigned destination folders. ⁴ mailing lists or eMail group aliases, advertising etc.

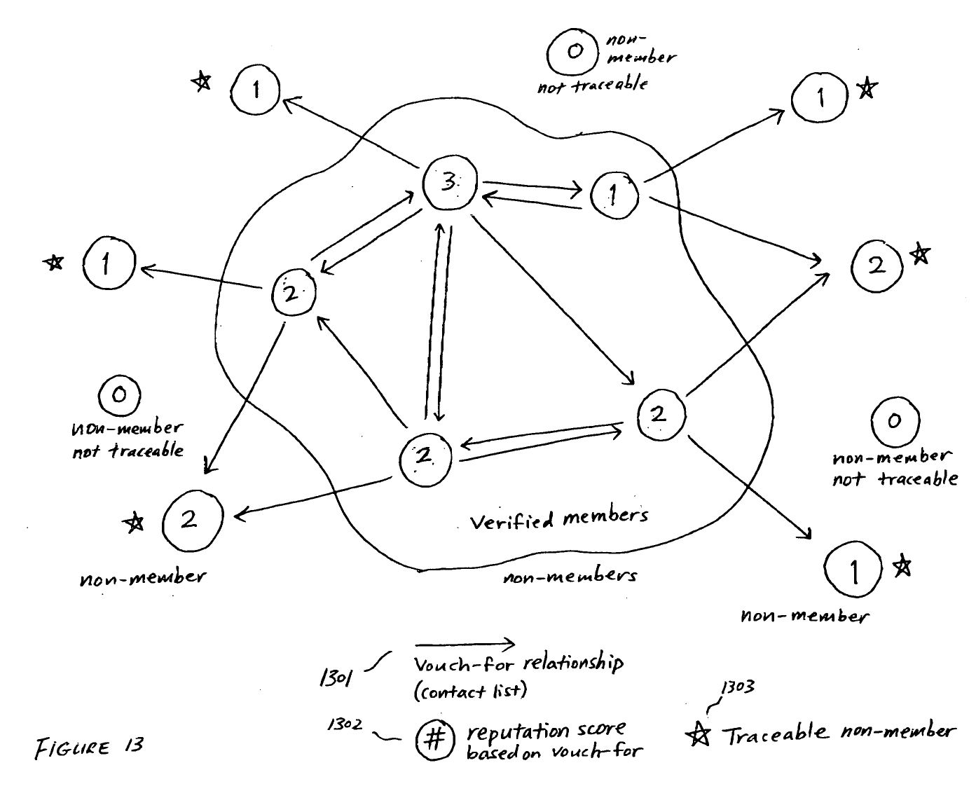

As illustrated in FIG. 13, a recipient member may also specify or upload a list of approved senders he or she would “vouch for” 1301, so as to allow eMail messages to be routed through without verification, or without payment of a sender's fee. Preferably, any such approved senders are invited to become verified members, when the list is entered or uploaded, or when an eMail message is sent by one of these senders to the member. Such approved contact lists 1301, when combined with other information or data about the persons therein (e.g., information available on the World Wide Web or from third-parties), allow the eMail service to assign or to augment a reputation rating 1302 for such persons, and additionally allow another member to “trace” a non-member 1303. In order to respect the traced person's privacy, the traced person or the member whose contact list provides the information on him or her, is sent a request-for-contact or a request-for-referral message, respectively, by the eMail service. The eMail address of the person being traced needs not be disclosed to the person requesting the trace. The eMail service may save a member's accepted or rejected incoming or outgoing eMail contacts to facilitate approval, rating, and tracing. For example, a member may elect to consider as approved any sender who replies to the member's prior eMail message, or to reject, for a specified time period, any eMail message from someone previously rejected.

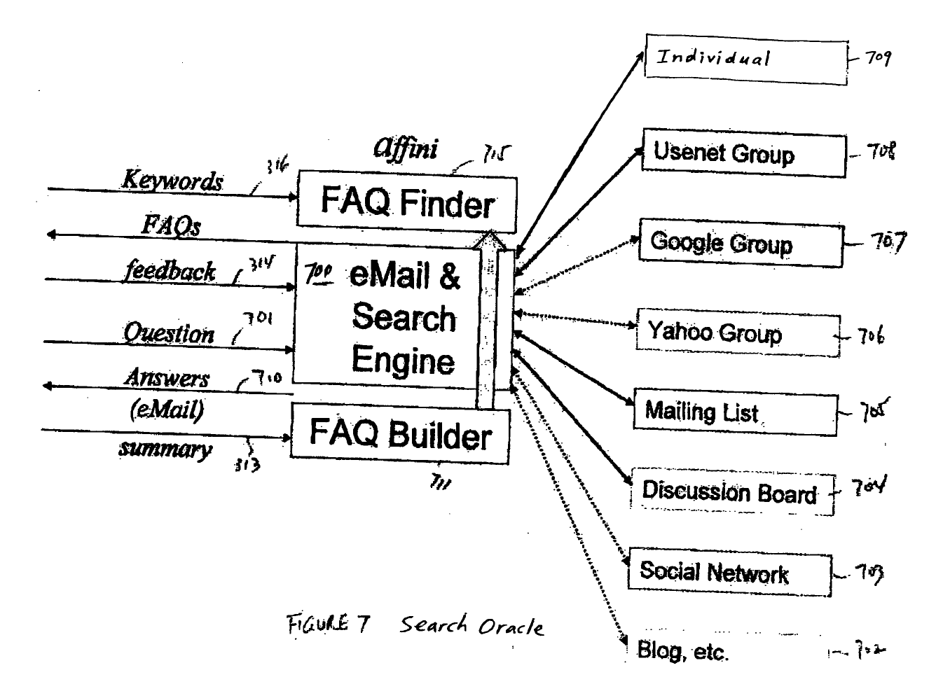

In addition to biographical, geographical, and demographical information, a member may also specify affinities or interests using keywords, phrases or inference rules. For example, a content search 111 or more specialized “search oracle” service 700 may be provided by affinity portal 100. Profile database 102 may infer affinity from the member's search history, mailing list subscriptions, the member's list of associations or merchants whose eMail messages should be allowed through or rejected, and the member's separate folders or mailboxes and associated filter or routing rules. Each declared affinity may carry a different sender's fee, or have the sender's fee shared differently with the referrer. Additionally, a member may list, for affinity purpose, favorite magazines (for horizontal targeting), music/musicians (for vertical targeting), products, web sites or online communities, and any online content that the member has created. A member can also provide (and organize) his or her collections, wanted, and for-sale lists, so that an affinity marketplace is thus enabled. A member may also declare areas of knowledge or expertise he is willing to provide consultation on by eMail. The member may specify a specific fee amount and the amount of consultation he is willing to provide for a given time period. FIG. 7 provides the operations of search oracle 700 in further detail. As shown in FIG. 7, questions 701 from other members are routed to a member 709 who specifies interest in receiving such questions, or in accordance with the specified criteria to any of appropriate affinity groups 702-708. Thus, for members who are subject experts or are celebrities, fee-bearing services may be conducted within such an online community; as well, an affinity group may itself charge fees for answering questions. Answers (for example, postings and eMail replies) from individuals 709 or affinity groups 702-708 responsive to questions 701 are collected and collated, and sent by eMail 710 to the members who posed the questions. Questions and answers are also archived and monitored, and when certain criteria are met (e.g., the number of times questions having a specific set of keywords exceed a specified threshold), the matching questions and answers are provided to FAQ builder 711 to be placed into a FAQ database. Members are encouraged to provide feedback (714) and summary (713) to search oracle service 700 to help improve, classify, rank and categorize the questions and answers in the FAQ database. Questions in the FAQ database are retrieved through FAQ finder 715, using keywords 716, for example. The FAQ database improves the human-scalability of the search oracle, i.e. fewer questions need to be answered by humans as the database increases in size.

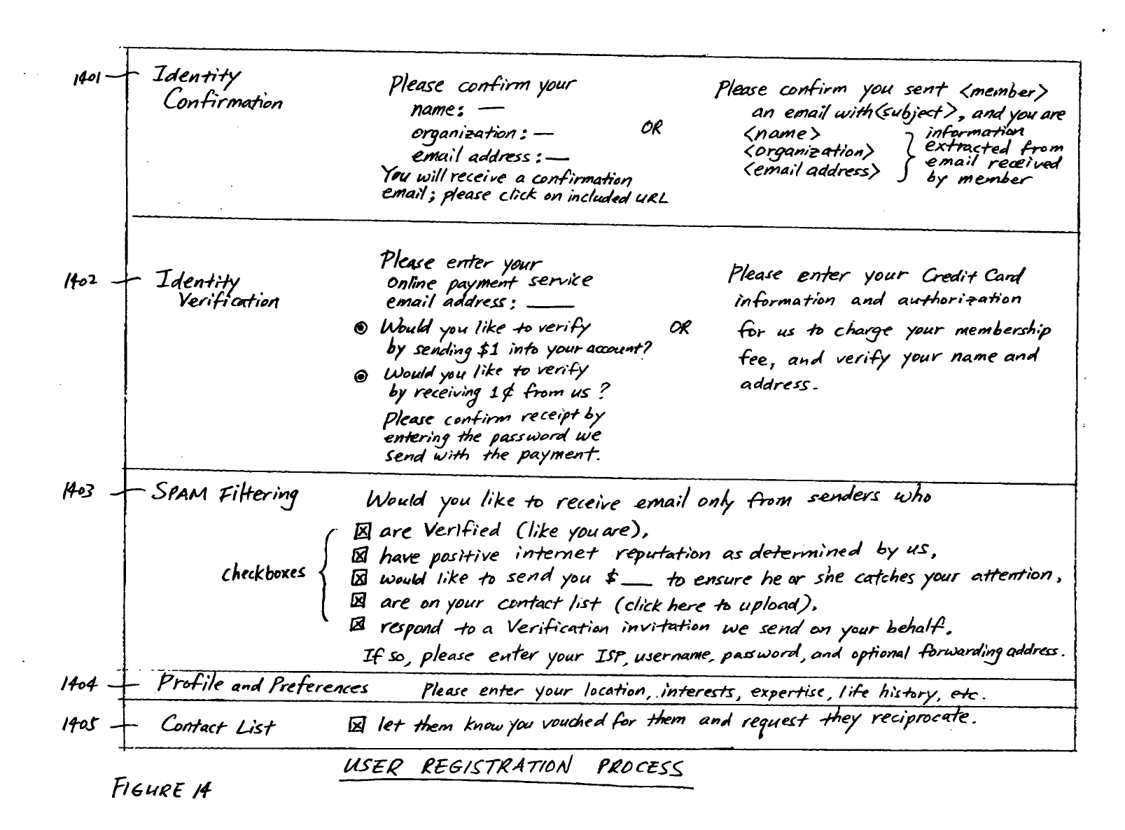

FIG. 14 summarizes the various, optional, steps in the user registration process, in accordance with one embodiment of the present invention. Identity confirmation 1401 occurs when a non-member tries to register at the service provider's web site, when he or she sends an eMail message to a member who requests sender verification, or when the sender is a member but the eMail had been sent using someone else's computer or eMail server (“roaming”), as determined from IP address in the eMail header. Identity verification 1402 then tries to create a financially-traceable connection with the user, by charging or crediting the user's existing, verified financial accounts with a credit card or an online payment service. Spam filtering 1403 gives the user control over the extent of sender verification the user finds desirable: “positive internet reputation” determined from “vouch-for” ratings by other members and from datamining the World Wide Web and internet archives; financially-verified sender who may be willing to pay a fee to the recipient; the user's contact list; positive response to a verification invitation. If the user chooses some form of spam filtering, he or she then enters the necessary information for the service provider to provide POP Messenger, POP Butler, or other eMail filtering services. The user then enters profile and preferences 1404 which go into profile database 102, electronic address directory 103, and subscriber settings 104. The user can enter or upload a contact list 1405 and choose whether to vouch for senders on the list (including mailing lists, online retailers, or other bulk eMail senders) thereby enhancing their reputation rating, and whether to request they reciprocate by vouching back.

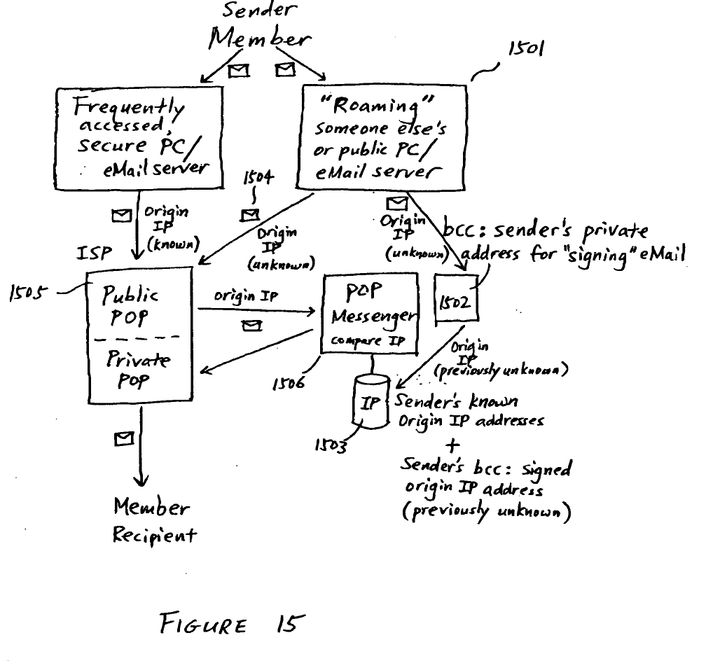

As illustrated in FIG. 15, a sender member can always notify the service provider he or she is roaming 1501 by visiting the web site or by “blind-copy” bcc: a special private address 1502 assigned to the member's account, which registers with database 1503 the origin IP address of the eMail server as valid for this sender, for a period of time. The “bcc: private address” method is generally applicable as a convenient means for a member to notify the service provider of his or her whereabouts (IP address of eMail server), or to authenticate or sign the eMail message that is sent as having come from the member and not from a spammer. (A spammer who “spoofs” or forges an eMail header From: address to be that of a sender member, cannot authenticate the eMail or the origin IP address in this manner, since the spammer does not know the bcc: private address; so the spoof will be caught based on invalid origin IP address which does not match any in database 1503 for the sender member.) When the thus signed eMail message 1504 reaches the recipient member's mailbox 1505, the service provider (for example POP messenger 1506) while checking the origin IP address against database 1503 will allow the eMail message to pass through, based on the bcc: signed eMail arriving at 1502 that shares the origin IP address with the eMail message 1504 addressed to the recipient. Thus, the roaming sender expediently adds a previously unknown eMail server 1501 to his or her list of known, valid “designated sender” eMail servers.

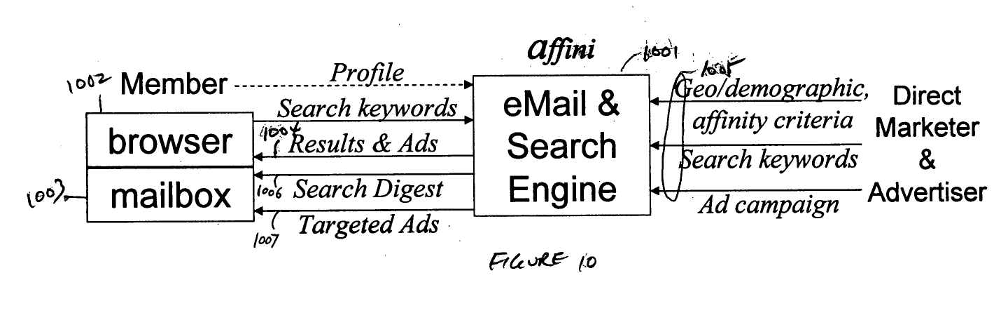

According to another embodiment of the present invention, a method for targeted advertisement, which is referred herein as “second-chance search advertisement” service, is illustrated in FIG. 10 by second chance advertisement service 1001. In second chance advertisement service 1001, a member may search for information in the WWW and from other sources, using a search box (1002) or by sending an eMail message (1003) to a specified eMail address (e.g. ask@Service or more selectively faq@Service, who@Service, whatis@Service, where2buy@Service), using keywords. When searching using an eMail message, the query is typically included in the subject line or in the message body. Result 1004 of the query, which may be returned via a web browser or in an eMail message, or both, may be accompanied by advertisements which are selected not only based on the keywords in the query, but also according to matching the querying member's identity and affinity with the advertisers specified desired criteria 1005. In addition, second chance search advertisement service 1001 may extract, re-position, modify or redirect the advertisement for various modes of delivery and tracking click-through, both on the results page or pages and separately via eMail. The results pages may also allow the user to select all or some of the results and request a search digest or summary 1006 to be sent by eMail for later use (possibly cumulatively over multiple searches). Additionally, a “try harder” button may be provided so that the member can request better results from the search engine, for example, through more time-consuming calculations, targeted web crawling and content discovery, or even by forwarding the query to a human expert or an online community, as provided by search oracle service 700 of FIG. 7. Replies to such requests may be delivered by eMail back to the member. Thus, through a combination of features and value-added services, the eMail service is in a position to send highly targeted eMail advertisement 1007, based on information derived from a member's search history and the member's declarative and behavioral profiles. Keyword based advertisements in search results are often ignored because the searcher is too focused on the search results. In contrast, because second chance search advertisement service 1001 has access to eMail address of the querying member, the service offers repeated opportunities and better targeting for advertisers to reach the querying member over time using fee-bearing eMail messages to the querying member, based on the member's search history. The querying member is more likely to be responsive to the resulting advertisement, as they are targeted to the querying member's needs and the fee-bearing eMail messages may be reviewed at the member's leisure.

The above detailed description is provided to illustrate the specific embodiments of the present invention. Numerous variations and modifications within the scope of the present invention are possible. For example, even though the embodiments disclosed above are illustrated using eMail as example, the present invention can be applicable to provide pay incentive credits to recipients of direct marketing calls via telephone, wireless, fax, pager, instant-messages, or other forms of electronic advertising, whether targeted at personal or business computers, or even postal services (e.g. a code or coupon affixed to a mailing label or the envelope, which can be used to obtain payment). The present invention is set forth in the following claims.

I claim:

1. A system comprising:
A subscriber profile database including electronic addresses and biographical and affinity information of subscribers to the system; and
a electronic address directory for retrieving from the subscriber profile database electronic addresses of selected subscribers based on a search criterion selecting a specified biographical or affinity profile.

2. A system as in claim 1, further comprising an electronic message forwarding service allowing sending electronic messages to the electronic addresses retrieved.

3. A system as in claim 1, wherein the electronic addresses are electronic mail addresses.

4. A system as in claim 2, wherein the electronic mail forwarding service associates a sender's fee on each electronic message sent to a subscriber.

5. A system as in claim 4, wherein the subscriber classifies senders of electronic messages into a plurality of classes, and specifies a fee schedule for electronic messages according to the classes.

6. A system as in claim 5, wherein the system provides tools for reclassifying a sender in a first class of senders to a second class of senders within the subscriber's classification.

7. A system as in claim 5, wherein the system provides tools for waiving a part of a sender's fee received for an electronic message received.

8. A system as in claim 5, wherein each electronic message is assigned a life time, and wherein upon expiration of the life time, the sender's fee is returned.

9. A system as in claim 2, wherein the electronic message forwarding service allows the subscriber to specify a number of electronic addresses according to the content of electronic messages to be received at each electronic address, the electronic message forwarding service forwarding each received electronic message to a corresponding electronic address according the content of the received electronic message.

10. A system as in claim 1, wherein the electronic addresses are verified from time to time to ensure integrity.

11. A system as in claim 1, wherein a subscriber specifies an out-of-service electronic address and a current electronic address to which electronic messages addressed to the out-of-service address are forwarded.

12. A system as in claim 11, further comprising an electronic message forwarding service allowing sending electronic messages to the electronic addresses retrieved, wherein the electronic message forwarding service verifying the out-of-service address by sending probing messages addressed to the out-of-service address from time to time to elicit a unsuccessful delivery reply.

13. A system as in claim 1, wherein the system further comprises tools for building an online community.

14. A system as in claim 1, wherein the database further comprises information of interest to the subscribers.

15. A system as in claim 14, wherein the information of interest is classified according to a plurality of taxonomy trees, each taxonomy tree being defined according to a value of a subscriber-provided property.

16. A system as in claim 14 wherein the information of interest comprises results of searches of information resources accessible on the internet.

17. A system as in claim 16, wherein the information resources comprises web pages of the world wide web.

18. A system as in claim 17, wherein the information resources comprises affinity groups.

19. A system as in claim 15, wherein queries regarding the information of interest is retrieved, upon receipt of a query, by searching the plurality of taxonomy trees.

20. A system as in claim 15, wherein the information of interest is retrieved, upon receipt of a query in an electronic message, by forwarding the electronic message to an electronic address specified by a subscriber who advertises expertise in a subject matter of the query.

21. A system as in claim 15, wherein the information of interest includes celebrity personal information which is retrieved, upon receipt of a query in an electronic message, by forwarding the electronic message to an electronic addressed specified by a corresponding celebrity subscriber.

22. A system as in claim 14, wherein queries to retrieved the information of interest and responses to the queries are selectively included in a frequently asked questions database.

23. A system as in claim 22, wherein the frequently asked questions database is improved by subscribers provided feedback.

24. A system as in claim 1, further comprising a transaction tracking service which tracks responses to a subscriber's registration messages and responses and collect information regarding subject matters of the subscriber's registrations messages.

25. A system as in claim 24, wherein the collected information is integrated into the subscriber profile database.

26. A system as in claim 25, further comprising an electronic message forwarding service allowing sending electronic messages to the electronic addresses retrieved, wherein the electronic message forwarding service comprises an electronic message route-through servcie.

27. A system as in claim 26, wherein the electronic route-through service retrieves electronic messages from a subscriber's public mailbox, processes the retrieved electronic messages by a subscriber-specified service, and forwards the processed electronic messages to the subscriber's private mailbox.

28. A system as in claim 27, wherein the subscriber-specified service comprises verification of identities of senders of the retrieved electronic messages.

29. A system as in claim 27, wherein the electronic route-through service periodically accesses a subscriber's mailbox to process electronic messages in the public mailbox by a subscriber-specified service.

30. A system as in claim 27, wherein the subscriber-specified service comprises verification of identities of senders of the electronic messages in the subscriber's mailbox.

31. A system as in claim 4, wherein the sender's fee levied on an electronic message for each subscriber is specified by the subscriber.

32. A system as in claim 31, further a comprises a subscriber search gateway that enables a sender (1) to search the electronic address directory to retrieve electronic addresses based on a combination of two or more of keywords, biographical, affinity information, and the sender's fees and (2) to send messages through the electronic message forwarding service messages to a portion of the electronic addresses retrieved accompanied by the sender's fees.

33. A system as in claim 32, further comprising an electronic message mailbox service for each subscriber that provides a ranking of electronic messages sent to the subscriber, and wherein the is allowed to provide a premium fee greater than the sender's fee specified by the subscriber to obtain a higher ranking than electronic messages providing the sender's fee specified by the subscriber.

34. A system as in claim 33, wherein the electronic message mailbox service allows a subscriber to specify a daily maximum limit on the number of eMail messages that is received from unsolicited sources.

35. A system as in claim 4, wherein the electronic message forwarding service sends a sender of electronic message not accompanied by a sender's fee an invoice for the sender's fee, and defers forwarding the electronic message until the invoice is paid.

36. A system as in claim 32, wherein the subscriber search gateway further enables the sender to redirect, when an electronic message sent to one of the electronic addresses retrieved is unread after a specified time period to another one of the electronic addresses retrieved.

37. A system as in claim 1, further comprising a content search gateway which enables a subscriber to search for information in one or more information resources using a query, wherein the content search gateway processes both the query and the result of the search to update affinity information of the subscriber in the subscriber profile database.

38. A system as in claim 37, wherein the content search gateway supports searching using a browser to access the world wide web.

39. A system as in claim 38, wherein the content search gateway supports searching using an eMail message.

40. A system as in claim 37, further a comprises a subscriber search gateway that enables a sender (1) to search the electronic address directory to retrieve electronic addresses based on a combination of two or more of keywords, biographical, affinity information, and the sender's fees and (2) to send messages through the electronic message forwarding service messages to a portion of the electronic addresses retrieved accompanied by the sender's fees.

41. A system as in claim 37, wherein the content search gateway includes commercial information with the result to the query that is retrieved based on both the query and the subscriber's affinity information in the subscriber profile database.

42. A system as in claim 41, wherein the content search gateway tracks the subscriber's response to the commercial information included in the result.

43. A system as in claim 37, wherein the content search gateway provides the subscriber a search digest.

44. A system as in claim 43, wherein the search digest summarizes the results of more than one query.

45. A system as in claim 44, wherein the content search gateway enables a subscriber to select a plurality of search algorithms from a group including algorithms of different levels of sophistication, targeted spidering and content discovery, and forwarding the query to a human expert or an online community.
